(19) United States
(12) Patent Application Publication
(10) Pub. No.: US 2013/0111074 A1
(43) Pub. Date: May 2, 2013

(54) METHOD FOR CHANGING AN OPERATING MODE OF AT LEAST ONE DEVICE

(71) Applicants: Volker Blaschke, Ludwigsburg (DE); Juergen Schirmer, Heidelberg (DE); Timo Lothspeich, Gerlingen (DE); Tobias Lorenz, Schwieberdingen (DE); Clemens Schroff, Kraichtal (DE)

(72) Inventors: Volker Blaschke, Ludwigsburg (DE); Juergen Schirmer, Heidelberg (DE); Timo Lothspeich, Gerlingen (DE); Tobias Lorenz, Schwieberdingen (DE); Clemens Schroff, Kraichtal (DE)

(21) Appl. No.: 13/696,459

(22) PCT Filed: Apr. 7, 2011
(86) PCT No.: PCT/EP2011/055422

§ 371 Date: Jan. 11, 2013

(30) Foreign Application Priority Data
May 6, 2010 (DE) 102010028665.6

(51) Int. Cl. G06F 3/00

(52) U.S. Cl. CPC G06F 3/00
USPC 710/14

(57) ABSTRACT

A method for changing an operating mode of at least one device, multiple compare registers, each having a bit pattern, being associated with the at least one device, is provided in which a data packet transmitted via a network is received by the at least one device, a content of the data packet being compared to the bit patterns of the associated compare registers, and in which a change in the operating mode of the at least one device takes place when the at least one device detects conformity of a bit pattern of the associated compare registers with the content of the data packet.

### CROSS REFERENCE TO RELATED APPLICATION

The present application is the national stage entry of International Patent Application No. PCT/EP2011/055422, filed on Apr. 7, 2011, which claims priority to Application No. DE 10 2010 028 665.6, filed in the Federal Republic of Germany on May 6, 2010.

### FIELD OF INVENTION

The present invention relates to a method for changing an operating mode of at least one device designed as a node of a network and a device of this type.

### BACKGROUND INFORMATION

In networks, different nodes or users are connected to each other, among which data, and thus information, may be exchanged via the network with the aid of signal transmission. The present invention relates to a possibility of operating nodes of a network in a suitable manner.

In this regard, a “wake on LAN” (WOL) function for waking up nodes of a local, spatially limited network (LAN) is known from the PC technology. This function normally enables waking up a single node in the network in a targeted manner. In this process, a so-called “magic packet” is transmitted to a network interface card of a node, and a node, designed as a computer, for example, is switched on upon receiving the magic packet. This packet contains the hexadecimal value “FF” six times consecutively; immediately thereafter, the uninterrupted 16-fold repetition of the physical address, normally the Media Access Control (MAC) address, of the node appears. The magic packet may occupy any position within a frame in a message via which it is transmitted. This makes it possible to transmit the message using any desired protocol, for example, Ethernet (cable-bound data network), IP (Internet Protocol), TCP (Transmission Control Protocol), or UDP (User Datagram Protocol).

However, waking up multiple nodes using a single message is not provided. The hardware address of the node to be woken up must also be already known to the transmitter, since no higher protocols are supported in a sleep mode.

For a system to be able to be woken up via a bit pattern, the receiving device must be active in a first layer (layer 1, physical layer). The transmitting device may be off. Depending on the implementation, it is now possible to recognize the bit pattern and to supply it to a wake-up module. There are also implementations which use the second layer (layer 2, data link) for decoding.

Mechanisms which wake up nodes via a bus system are also known from the automotive technology. In a CAN (Controller Area Network), wake-up occurs via detection or confirmation of a bus activity, and in FlexRay, via transmission of a defined code. However, waking up individual nodes or groups of nodes in a network is currently not supported in vehicles.

In FlexRay, the bit pattern for waking a node is fixedly predefined. Here, it is referred to as a pattern. However, no configuration possibility is provided for this pattern. The structure of the pattern for FlexRay is “idle-0-1-0-1” or “idle-0-idle-0-idle.” Each phase (idle, 0, 1) has a length of 4 μs. This pattern may be placed directly on the bus or it may be the payload of a frame. In the latter case, the 1 of the BSS (byte start sequence) is ignored.

### SUMMARY

With the aid of the present invention, a so-called multicast waking and a broadcast waking may be implemented in a network designed as an Ethernet which is normally cable-bound, thus allowing multiple or possibly all nodes or users of a network of this type to be woken up. In the case of multicast waking, at least two and therefore multiple nodes may be woken up starting from one point of the network, typically via a multipoint link. In the case of broadcast waking, all nodes of the network may be woken up via transmission of messages. The nodes described herein are usually devices for data processing, which may interact with each other as nodes of the network if they are connected to each other via the network.

Having the possibility of waking multiple nodes simultaneously using a message as an integral part of a data packet, the network management previously used in the vehicle may continue to be used even after an Ethernet is introduced as the network in the vehicle.

Within the scope of the present invention, at least one node is configured in such a way that at least one of the following scenarios is supported:
waking one node when different special messages, and thus data packets, are received,
waking a selection of nodes or a group of nodes, which are interconnected via an Ethernet, using a certain message, and/or
waking all nodes interconnected via an Ethernet using a certain message.

The device according to the present invention is designed for performing all steps of the above-presented method. Individual steps of this method may also be performed by individual, components of the device. Furthermore, functions of the device or functions of individual components of the device may be implemented as steps of the method. In addition, it is possible to implement steps of the method as functions of at least one component of the device or of the entire device.

Within the scope of the present invention it is provided that the wake-up logic of a device, which may be designed as a node or user of an Ethernet or of a cable-bound network for transmission of data, may be extended by additional compare registers, which may be designed as configurable memory cells. These additional compare registers may be provided exclusively for storing the bit pattern, which are compared to the contents of the data packet received in order to change or modify the operating mode of the device. These additional compare registers thus represent an extension of the device, which otherwise may have other compare registers for other purposes. Accordingly, multiple compare registers having bit patterns are integrated in one device. These compare registers may be configured in different manners.

By configuring the compare registers it is possible to define multiple bit patterns, via which the network device, normally designed as a node, after being set into the sleep mode may exit this mode again. When used in the automotive industry, a node or a device is designed as a sensor, an actuator, or a control unit for at least one component of a motor vehicle.

For this purpose, the device or the node compares the content of data packets received within transmitted data streams and thus transmitted messages for conformity with the contents of the compare registers and thus with multiple bit patterns, which are provided for the at least one device.

As soon as the device detects conformity of the content of at least one compare register, in general of the bit pattern, at any point of a data packet within a data stream, the change in the operating mode occurs, i.e., from a sleep mode to a wake-up mode and thus to a normal operating mode in which the device is able to execute all functions.

In the sleep mode, which may also be referred to as a hibernation mode, the device normally executes only a few basic functions, so that the device is in a kind of stand-by mode.

The content of a transmitted data packet normally includes multiple pieces of data; a piece of data may be coded and/or configured as a bit pattern as described above which causes at least one device to change its operating mode. Bit patterns of this type, which are transmitted with the data packet, may also be referred to as so-called change bit patterns.

If multiple devices are configured using one bit pattern, which is identical for all of these devices, it is then possible to wake up this group of devices simultaneously using the same bit pattern. Since several compare registers are configured for one device, a device may be woken up by different bit patterns in different compare registers which are associated with this device. This makes it possible, for example, to define a device designed as a node as belonging to multiple groups of nodes within the network.

The size of a compare register and/or a bit pattern stored therein is arbitrary and may be selected according to the requirements provided with regard to a data transmission within the network. Based on a current standard, 42 bytes=6 bytes+6*6 bytes are conceivable for the size of the compare register and/or of the bit pattern stored therein.

Multiple bit patterns described above, which are stored in the compare registers, are associated with one device. Using at least one bit pattern, identification of a device and thus, for example, association of a device with multiple groups of devices is thus possible. Accordingly, a bit pattern of this type is typically provided for identifying a device within the network.

Furthermore, any configuration may also be integrated, according to which a decision is made whether the content of a compare register is to be used at all for the comparison. The deactivation of a compare register may be controlled, for example, via its content. It is thus conceivable that a configuration of a compare register whose content includes only zeros results in deactivation of the compare register. Alternatively or additionally, a compare register may be deactivated if the bit pattern has only zeros and/or includes a predefined structure. In general, any other register value or another precautionary measure is also conceivable for this purpose. A compare register may be activated and/or a bit pattern to be stored in a compare register may be generated with the aid of suitable measures if necessary at any time.

To extend the configuration possibilities of compare registers, the possibility of chaining and then connecting any number of existing compare registers, and/or linking contents, normally bit patterns stored in the comparison system, across compare registers, may also be provided. It is thus possible to also provide bit patterns which are longer than a single compare register.

In another embodiment, the compare registers are populated automatically using a standard bit pattern, which may be done immediately after switching on or after resetting a device, and then the bit pattern is stored in the compare register independently from its mode. Manual configuration, for example, via software, may then be omitted. In this case it is also conceivable to provide an option for selecting the standard bit pattern. This may be accomplished, for example, by connecting one or more pins of the device designed as a node.

The compare registers may be typically integrated into any memory technology, such as RAM, EEPROM, or FLASH.

Within the scope of the present invention it may also be provided that a compare register is used for changing between any two operating modes of a node.

Thus, in one variant of the present invention, in addition to changing a device from the sleep mode to the wake-up mode and thus to a normal operating mode via a message configured as a wake-up message within a data packet, a change from the wake-up mode to the sleep or hibernation mode is also possible. The above-described method has sufficient operational reliability for this purpose.

A functionality of this type of messages has previously been made possible on higher open system interconnection (OSI) levels and thus levels of a layer model according to the International Organization for Standardization (ISO), but it requires an appropriately high degree of software complexity.

With the aid of the present invention, it is also possible to transmit, as the contents of a data packet, a bit pattern which is identical for multiple nodes and thus devices in a multicast or broadcast message and thus to change their operating mode.

The compare registers may be associated with the device regardless of whether or not the device is connected to the network. Typically, the device is designed as a node or user of the network if it is connected to the network.

If a device is temporarily disconnected from the network, after it is reconnected to the network it may be woken up by receiving a data packet, whose content, i.e., change bit pattern, is in conformity with the bit patterns of the compare registers of the device for which the operating mode is to be changed.

In general, the devices of the network referred to as nodes may be designed as so-called slaves, whose operating modes may be typically changed by a higher-level device designed as a master by transmitting data packets having suitable contents. It is, however, also possible that the devices designed as slaves exchange data packets among themselves within a network, thus being able to mutually change and thus modify their operating modes.

In one possible exemplary embodiment of the method according to the present invention, higher protocols such as a network protocol (IP, Internet Protocol) or a transport protocol (UDP, User Datagram Protocol) may be used for waking up the device from the sleep mode. Alternatively or additionally it is also possible to use the higher layers 3 through 7 for waking up the device.

The present invention may be generally used, for example, for a vehicle designed as a motor vehicle, which includes a network having a number of different devices.

Further advantages and exemplary embodiments of the present invention are set forth in the following description and the accompanying drawing.

It is understood that the above-named features and the features to be elucidated below are usable not only in the particular given combination, but also in other combinations or alone without departing from the scope of the present invention.

### BRIEF DESCRIPTION OF THE DRAWINGS

FIG. 1 schematically shows a network, which includes multiple examples of devices according to the present invention when an exemplary embodiment of the method according to the present invention is executed.

### DETAILED DESCRIPTION

The present invention is schematically illustrated in the drawing on the basis of an exemplary embodiment and described in greater detail in the following with reference to the accompanying drawing.

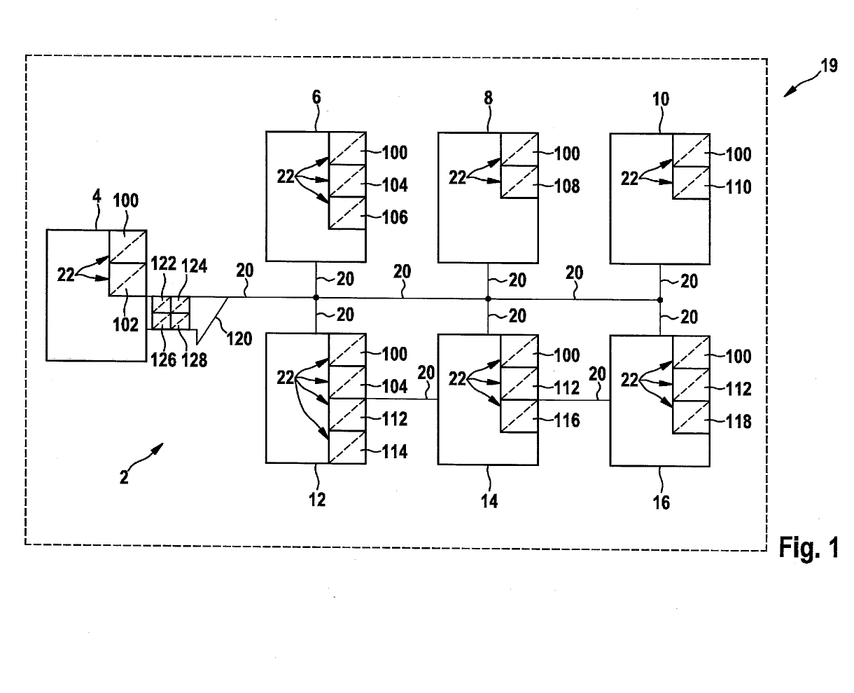

FIG. 1 schematically shows a network 2, which includes multiple devices 4, 6, 8, 10, 12, 14, 16. These devices 4, 6, 8, 10, 12, 14, 16 are designed for carrying out data processing operations, normally computing operations.

In addition, these devices 4, 6, 8, 10, 12, 14, 16 are connected to each other via network 2 via physical connecting elements 20, which in this case are designed as cables. It is thus possible for devices 4, 6, 8, 10, 12, 14, 16 to exchange data, which are typically provided via electrical signals via physical connecting elements 20 of network 2.

It is provided that the above-described network 2 is situated in a vehicle, which is designed herein as a motor vehicle 19 and surrounded by a dashed line.

In the exemplary embodiment of the present invention described here, it is provided that each device 4, 6, 8, 10, 12, 14, 16 has multiple configurable memory cells 22, which are symbolically represented here as rectangles. Multiple associated compare registers are integrated into each device 4, 6, 8, 10, 12, 14, 16 within the configurable memory cells 22 illustrated here. It is furthermore provided that in each compare register integrated into one of memory cells 22, a bit pattern 100, 102, 104, 106, 108, 110, 112, 114, 116, 118 is stored. Such a bit pattern 100, 102, 104, 106, 108, 110, 112, 114, 116, 118 may be generated and/or modified dynamically during operation.

In detail, it is provided in the exemplary embodiment of the present invention that in a first device 4 a first compare register has a first bit pattern 100 and a second compare register has a second bit pattern 102. In a second device 6, a first compare register has first bit pattern 100, a second compare register has a third bit pattern 104, and a third compare register has a fourth bit pattern 106. In a third device 8, a first compare register also has first bit pattern 100, and a second compare register has a fifth bit pattern 108. In a fourth device, it is provided that a first compare register has first bit pattern 100 and a second compare register has a sixth bit pattern 110. In a fifth device 12, it is provided that a first compare register has first bit pattern 100, a second compare register has third bit pattern 104, a third compare register has a seventh bit pattern 112, and a fourth compare register has an eighth bit pattern 114. In a sixth device 14, a first compare register has first bit pattern 100, a second compare register has seventh bit pattern 112, and a third compare register has a ninth bit pattern 116. In a seventh device 16, a first compare register has first bit, pattern 100, and a second compare register has a tenth bit pattern 118.

Furthermore, FIG. 1 shows a data packet 120, schematically illustrated by an arrow, which in this case includes multiple bit patterns as content, which are referred to here as so-called change bit patterns 122, 124, 126, 128. This data packet 120 is to be transmitted within network 2 via connecting elements 20 of network 2. The bit patterns designed as change bit patterns 122, 124, 126, 128 within data packet 120 are provided for causing a change in an operating mode of at least one of devices 4, 6, 8, 10, 12, 14, 16.

Using the exemplary embodiment of the method described here it is possible to perform a change in an operating mode of at least one device 4, 6, 8, 10, 12, 14, 16 connected to network 2. At least two, and thus multiple, compare registers having bit patterns 100, 102, 104, 106, 108, 110, 112, 114, 116, 118 stored therein are associated with the at least one device 4, 6, 8, 10, 12, 14, 16. When carrying out the method, data packet 120, transmitted via connecting elements 20 of network 2, is received by the at least one device 4, 6, 8, 10, 12, 14, 16, and the content of data packet 120, i.e., change bit patterns 122, 124, 126, 128, is compared to bit patterns 100, 102, 104, 106, 108, 110, 112, 114, 116, 118 of the compare registers, which are associated with devices 4, 6, 8, 10, 12, 14, 16. A change in the operating mode of the at least one device 4, 6, 8, 10, 12, 14, 16 occurs when the at least one device 4, 6, 8, 10, 12, 14, 16 detects or confirms conformity of its own bit pattern 100, 102, 104, 106, 108, 110, 112, 114, 116, 118 of the associated compare registers with the content of received data packet 120. For this purpose, devices 4, 6, 8, 10, 12, 14, 16 compare bit patterns of change bit patterns 122, 124, 126, 128 to the corresponding bit patterns 100, 102, 104, 106, 108, 110, 112, 114, 116, 118 stored in the compare registers.

As FIG. 1 shows, the compare registers of all devices 4, 6, 8, 10, 12, 14, 16 have first bit pattern 100. Now, if first bit pattern 100 is transmitted having data packet 120 as the content via one of change bit patterns 122, 124, 126, 128, operating modes of all devices 4, 6, 8, 10, 12, 14, 16 are changed.

In addition, it is apparent from FIG. 1 that each compare register having third bit pattern 104 is associated with second device 6 and fifth device 12 within a configurable memory cell 22. Under this prerequisite, second device 6 and fifth device 12 form a first group within network 2. The operating modes of both of these above-named devices 6, 12 may now be changed by transmitting third bit pattern 104 via data packet 120 as one of change bit patterns 122, 124, 126, 128.

Furthermore, fifth, sixth, and seventh devices 12, 14, 16 share the feature that a compare register having shared seventh bit pattern 112 is associated with each of the configurable memory devices 22 of three above-named devices 12, 14, 16. Accordingly, fifth, sixth, and seventh devices 12, 14, 16 form a second group within network 2. Operating modes of these three devices 12, 14, 16 of the second group are changed in one embodiment of the method by transmitting seventh shared bit pattern 112 provided for devices 12, 14, 16 of the second group, via data packet 120, as one of change bit patterns 122, 124, 126, 128.

In addition, each device 4, 6, 8, 10, 12, 14, 16 has an individual bit pattern 102, 106, 108, 110, 114, 116, 118 provided only for particular device 4, 6, 8, 10, 12, 14, 16. In detail, first device 4 has in this case individual second bit pattern 102, second device 6 has individual fourth bit pattern 106, third device 8 has individual fifth bit pattern 108, fourth device 10 has individual sixth bit pattern 110, fifth device 12 has individual eighth bit pattern 114, sixth device 14 has individual ninth bit pattern 116, and seventh device 16 has individual tenth bit pattern 118.

Above-named bit patterns 100, 102, 104, 106, 108, 110, 112, 114, 116, 118 may also be changed dynamically during the operation of devices 4, 6, 8, 10, 12, 14, 16. It is thus possible, among other things, to flexibly define and thus change as needed an association of a device 4, 6, 8, 10, 12, 14, 16 with a certain group within network 2.

If, in one exemplary embodiment of the method according to the present invention, one of above-mentioned individual bit patterns 102, 106, 108, 110, 114, 116, 118 is transmitted having data packet 120 as one of change bit patterns 122, 124, 126, 128, only one operating mode of the particular device 4, 6, 8, 10, 12, 14, 16 is changed, as soon as a particular device 4, 6, 8, 10, 12, 14, 16 receives the particular associated individual bit pattern 102, 106, 108, 110, 114, 116, 118.

Within the scope of the method, various operating modes of devices 4, 6, 8, 10, 12, 14, 16 within network 2 may be changed and thus modified by transmitting particular selected bit patterns 100, 102, 104, 106, 108, 110, 112, 114, 116, 118 within data packets 120.

It is normally provided that at least one device 4, 6, 8, 10, 12, 14, 16, changes from a hibernation or sleep mode to a wake-up mode upon receiving a bit pattern 100, 102, 104, 106, 108, 110, 112, 114, 116, 118, which is identical to one of change bit patterns 122, 124, 126, 128 of a data packet 120.

Alternatively or additionally, it is also possible that in the event of an intended change in an operating mode, a device 4, 6, 8, 10, 12, 14, 16, is changed from a wake-up mode to a hibernation or sleep mode upon receiving a bit pattern 100, 102, 104, 106, 108, 110, 112, 114, 116, 118 associated with these devices 4, 6, 8, 10, 12, 14, 16 as the content of data packet 120.

In network 2 schematically illustrated in FIG. 1, it is provided, without limiting the generality of the description, that first device 4 is designed as a so-called master within network 2, and all other devices 6, 8, 10, 12, 14, 16 are designed as so-called slaves within network 2.

Accordingly, in the present exemplary embodiment of the present invention, data packet 120 is transmitted by first device 4, designed as a master, to the other devices 6, 8, 10, 12, 14, 16 designed as slaves, so that the operating modes of devices 6, 8, 10, 12, 14, 16 are changed according to the bit patterns 100, 102, 104, 106, 108, 110, 112, 114, 116, 118 transmitted as the contents of data packet 120.

It is, however, also possible that, starting from first device 4 as the master of network 2, this device 4 is able to change its own operating mode, as long as either bit pattern 100 or 102 as one of change bit patterns 122, 124, 126, 128 is transmitted as a content within data packet 120. Normally, all devices 4, 6, 8, 10, 12, 14, 16, designed as slaves, may transmit data packets 120 having change bit patterns 122, 124, 126, 128 as the contents and thus cause the operating modes of other devices 4, 6, 8, 10, 12, 14, 16 to change.

Since multiple bit patterns 100, 102, 104, 106, 108, 110, 112, 114, 116, 118 may be associated with a device 4, 6, 8, 10, 12, 14, 16, it is possible to define this device 4, 6, 8, 10, 12, 14, 16 as belonging to multiple groups of devices 4, 6, 8, 10, 12, 14, 16 and thus nodes within network 2.

Thus, second device 6 belongs to two groups, since first bit pattern 100 and third bit pattern 104, among others, are associated with this device 6. First bit pattern 100, third bit pattern 104, and seventh bit pattern 112, among others, are associated with fifth device 12, so that fifth device 12 is associated with and therefore belongs to three groups. First bit pattern 100 and seventh bit pattern 112 are each associated with sixth device 14 and seventh device 16, so that these two devices 14, 16 belong to the same two groups.

1-10. (canceled)

11. A method for changing an operating mode of at least one device, multiple compare registers each having a bit pattern associated with the at least one device, the method comprising:
receiving, by the at least one device, a data packet transmitted via a network, a content of the data packet being compared to the bit patterns of the associated compare registers; and
changing the operating mode of the at least one device when the at least one device detects conformity of the bit patterns of the associated compare registers with the content of the data packet.

12. The method according to claim 11, wherein, in an event of a change in the operating mode, the at least one device is changed at least one of from a hibernation or sleep mode to a wake-up mode, and from a wake-up mode to a hibernation or sleep mode.

13. The method according to claim 11, further comprising:
defining multiple devices within the network as a group of devices, at least one compare register having a bit pattern identical to that of the devices being associated with all devices of the group; and
changing operating modes of the devices of the group when the devices detect conformity of the identical bit pattern with the content of the received data packet.

14. The method according to claim 11, further comprising:
activating or deactivating a compare register via the bit pattern stored in the compare register.

15. The method according to claim 11, further comprising:
chaining multiple compare registers to one compare register.

16. The method according to claim 11, further comprising:
storing a standard bit pattern in the compare registers after the at least one device is switched on or reset.

17. The method according to claim 11, wherein the at least one device is configured as a node of a cable-bound network for transmission of data.

18. The method according to claim 11, wherein the at least one device is configured as a node of a network situated in a motor vehicle.

19. A device with which multiple compare registers, each having a bit pattern, are associated, the device configured to receive a data packet which is transmitted via a network, to compare a content of the data packet to the bit patterns of the associated compare registers, and to perform a change in an operating mode when the device detects conformity of the bit patterns of the associated compare registers with the content of the data packet.

20. The device according to claim 19, wherein the compare registers are configured as configurable memory cells.
